(19) United States
(12) Patent Application Publication
(10) Pub. No.: US 2018/0299831 A1
(43) Pub. Date: Oct. 18, 2018

(54) Crown Pusher Assembly and Wristwearable Electronic Device Comprising Same

(71) Applicant: Timex Group USA, Inc., Middlebury, CT (US)

(72) Inventors: Julius Michael Odi, Mandaue City, Cebu (PH); Brian J. Hudson, Watertown, CT (US)

(21) Appl. No.: 15/953,821

(22) Filed: Apr. 16, 2018

Related U.S. Application Data
(60) Provisional application No. 62/486,724, filed on Apr. 18, 2017.

(51) Int. Cl. G04B 27/00; G04G 21/00

(52) U.S. Cl. CPC G04B 27/002; G04G 21/00

(57) ABSTRACT

A crown assembly for an electronic device. The crown assembly includes a crown, coupled to a rotatable stem assembly, and a sleeve assembly coupled to the crown and the rotatable stem assembly, wherein the sleeve assembly causes the rotatable stem assembly to be axial displaceable in a first axial direction from the “run” stem position to a “setting” stem position and causes electrical contact between two contacts upon a pushing of the crown in a second axial direction to a “pushed” crown position, while the rotatable stem assembly is not axial displaceable in the second axial direction passed its normal “run” stem position.

### BACKGROUND OF THE INVENTION

The present invention is directed generally to wristworn electronic devices, including but not limited to timepieces including but not limited to digital timepieces, analog timepieces and combined analog and digital timepieces, and in particular, to an improved crown assembly construction that provides for both indicator adjustment and auxiliary function initiation. In particular, the present invention provides a versatile crown assembly construction that can be used with a wider range of electronic device movements than heretofore available.

Known to the present inventors is a timepiece construction described in U.S. Pat. No. 5,644,553 that has a combined crown and pushbutton arrangement. For example, described and illustrated in the aforementioned '553 patent, and as illustrated herein in FIG. 1A is a stem 112 positioned in the normal or “run” position, while FIG. 1B herein illustrates stem 112 having been pushed axially inward toward the movement into the “switching” position. In particular and relevant to the present invention, one can see in FIG. 1B that stem 112 has been pushed to the left from the normal “run” position of FIG. 1A against the biasing force of a spring switching arm 116. Slightly before a detent spring engages a stopping flange to prevent further leftward movement of stem 112, contacts 133, 134 close a switch, which in the example of U.S. Pat. No. 5,644,553, causes the illumination of the dial (e.g. the backlighting). When the crown (not shown) is released, switching spring 116 causes the stem to move to the right, back to the position shown in FIG. 1A herein.

The construction of the crown pusher assembly of U.S. Pat. No. 5,644,553 works well and has been well received as part of wristworn electronic devices sold by Applicant. However, as seen in the '553 patent and FIGS. 1A and 1B herein, the crown pusher assembly of the prior art requires axial movement of the setting stem 112 inwardly in order to achieve the initiation of the backlighting function. In other words, along with a normal run position and a “pulling” (or setting position), the setting stem of the prior art requires movement in the “inward” (i.e. “pushing”) position so as to initiate the backlighting (i.e. auxiliary) function.

However, not all movements are designed alike. In fact, while most crown pushing assemblies have a normal “run” position and a “pulling” (or setting position), many setting stems of the prior art do not provide for an axial displacement in the “inward” or “pushing” position so as to achieve an auxiliary (e.g. backlighting) function.

But this is not surprising as many of such movements for wearable electronic devices contemplate the use of separate pushers to achieve auxiliary functionality such as backlighting or the like. In other words, many of the known movements contemplate and utilize the crown assembly solely for indicator (e.g. hand) setting while using separate pushers (e.g. at the 2, 4, 8 and/or 10 o'clock positions) for such auxiliary (e.g. backlighting) functionality.

It is thus believed that further advances in the art are both desirable and achievable. For example, there is a desire to improve the versatility and use of the crown assembly while further reducing the need for a separate pusher for at least one auxiliary (e.g. backlighting) function. Specifically, it is believe that the foregoing can be achieved by a universal crown pusher assembly that can be used with a wider range of movements, such as movements for timepieces.

### SUMMARY AND OBJECTIVES OF THE INVENTION

It is thus an objective of the present invention to overcome the perceived deficiencies in the prior art.

Specifically, it is an objective of the present invention to provide an improved crown assembly that can make a conventional watch movement more versatile and user friendly than heretofore.

Moreover, it is an object of the present invention to provide an improved crown assembly that can eliminate one or more side pushers normally reserved for initiating features or functions that now can be achieved using the crown assembly of the present invention.

It is a further objective of the present invention to incorporate the present invention is a wide range of wristworn electronic devices, such as those of the “analog type” whether of the quartz analog or solid state type, and of the “digital type.”

It is a further object of the present invention to provide a timepiece that includes an improved crown assembly as disclosed herein, and which can be used for initiating an auxiliary function, such as a backlighting and/or laser pointer, just to name a few.

It is a further objective of the present invention to provide a timepiece that is more functional and aesthetically pleasing to a segment of the purchasing public.

And, it is further objective of the present invention to be able to utilize a wider array of watch movements, whether conventional or otherwise, which, in combination with the present invention, makes the wider array of watch movements more utilizable and functionally friendly.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

To overcome the perceived deficiencies in the prior art and to achieve the objects and advantages set forth above and below, the present invention is, generally speaking, directed to a crown assembly for an electronic device, wherein the electronic device comprises an auxiliary function initiatable in response to an electrical contact between a first contact and a second contact, and a rotatable stem assembly axially displaceable between at least a “run” stem position and a “setting” stem position, wherein the crown assembly comprises a crown, coupled to the rotatable stem assembly, the crown axially displaceable between a “run” crown position and a “setting” crown position and between the “run” crown position and a “pushed” crown position, wherein when the crown is in the “run” crown position the rotatable stem assembly is in the “run” stem position and when the crown is in the “setting” crown position the rotatable stem assembly is in the “setting” stem position; and a sleeve assembly coupled to the crown and the rotatable stem assembly, the sleeve assembly being axially displaceable in both a first axial direction and a second axial direction that is opposite the first axial direction, wherein the sleeve assembly causes the rotatable stem assembly to be axial displaceable in the first axial direction from the “run” stem position to the “setting” stem position; and causes electrical contact between the first and second contacts upon a pushing of the crown in the second axial direction to the “pushed” crown position.

In a second preferred embodiment, the present invention is directed to a crown assembly for an electronic device, wherein the electronic device comprises an auxiliary function initiatable in response to an electrical contact between a first contact and a second contact, and a rotatable stem assembly axially displaceable in a first direction between a first stem position and a second stem position, wherein the crown assembly comprises a crown, coupled to the rotatable stem assembly, the crown axially displaceable in the first direction between a first crown position and a second crown position and axial displaceable in a direction opposition the first direction between the first crown position and a third crown position, wherein when the crown is in the first crown position the rotatable stem assembly is in the first stem position; when the crown is in the second crown position the rotatable stem assembly is in the second stem position; and the rotatable stem assembly is not axially displaceable from the first stem position in the direction opposite the first direction; a sleeve assembly coupled to the crown and the rotatable stem assembly, the sleeve assembly being axially displaceable in both the first axial direction and the direction opposite the first axial direction, wherein the sleeve assembly urges the rotatable stem assembly to be axial displaceable in the first axial direction from the first stem position to the second stem position; and engages one of the first and second contacts against the other of the first and second contacts when the crown is in its third crown position; whereby when the first and second contacts are in electrical contact, the crown is in its third crown position and the rotatable stem assembly is in its first stem position.

And in yet a third preferred embodiment, the present invention is directed to an electronic device, comprising an auxiliary function initiatable in response to an electrical contact between a first contact and a second contact; a rotatable stem assembly axially displaceable between at least a “run” stem position and a “setting” stem position; and a crown assembly comprising a crown, coupled to the rotatable stem assembly, the crown axially displaceable between a “run” crown position and a “setting” crown position and between the “run” crown position and a “pushed” crown position, wherein when the crown is in the “run” crown position the rotatable stem assembly is in the “run” stem position, when the crown is in the “setting” crown position the rotatable stem assembly is in the “setting” stem position and when the crown is in the “pushed” crown position the rotatable stem assembly is in the “run” stem position; and a sleeve assembly coupled to the crown and the rotatable stem assembly, the sleeve assembly being axially displaceable in both a first axial direction and a second axial direction that is opposite the first axial direction, wherein the sleeve assembly (i) pulls the stem assembly in the first axial direction from the “run” stem position to the “setting” stem position and (ii) causes electrical contact between the first and second contacts when the crown is in the “pushed” crown position and the rotatable stem assembly is in the “run” stem position.

In a preferred embodiment, the electronic device is a wristworn timepiece.

### BRIEF DESCRIPTION OF THE DRAWINGS

For a fuller understanding of the invention, reference is had to the following description taken in connection with the accompanying figures, in which:

FIGS. 1A, 1B are cross-sectional views of a watch movement in accordance with the prior art;

FIG. 2 is a cross-sectional view of crown assembly constructed in accordance with a first preferred embodiment of the present invention;

FIG. 3 is a perspective view of a crown assembly constructed in accordance with the first preferred embodiment of the present invention;

FIGS. 4A, 4B and 4C are perspective views in cross-sectional cutaway of a crown assembly construction in accordance with the first preferred embodiment, showing the crown assembly and the rotating stem assembly in their respective (i) normal “run” crown position and normal “run” stem position (FIG. 4A), (ii) “setting” crown position and “setting” stem position (FIG. 4B) where it can be seen that the stem pinion gear is engaged to the movement gear train for e.g. time setting, and (iii) “pushed” crown position and normal “run” stem position (FIG. 4C); and

FIGS. 5A, 5B and 5C are perspective views in cross-sectional cutaway of a crown assembly construction in accordance with a second preferred embodiment, showing the crown assembly and the rotating stem assembly in their respective (i) normal “run” crown position and normal “run” stem position (FIG. 5A) where it can be seen that there is no engagement between the gear and the switch plate, (ii) “setting” crown position and “setting” stem position (FIG. 5B) where it can be seen that the switch plate is engaged with the stem pinion gear and that bidirectional rotation of the crown would activate the switch, and (iii) “pushed” crown position and normal “run” stem position where it can be seen that there is no engagement between the pinion gear and switch plate (FIG. 5C).

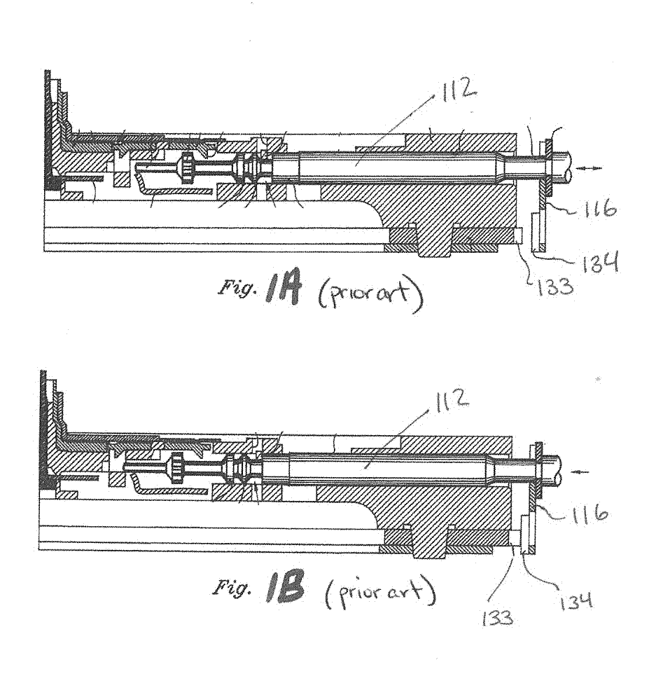

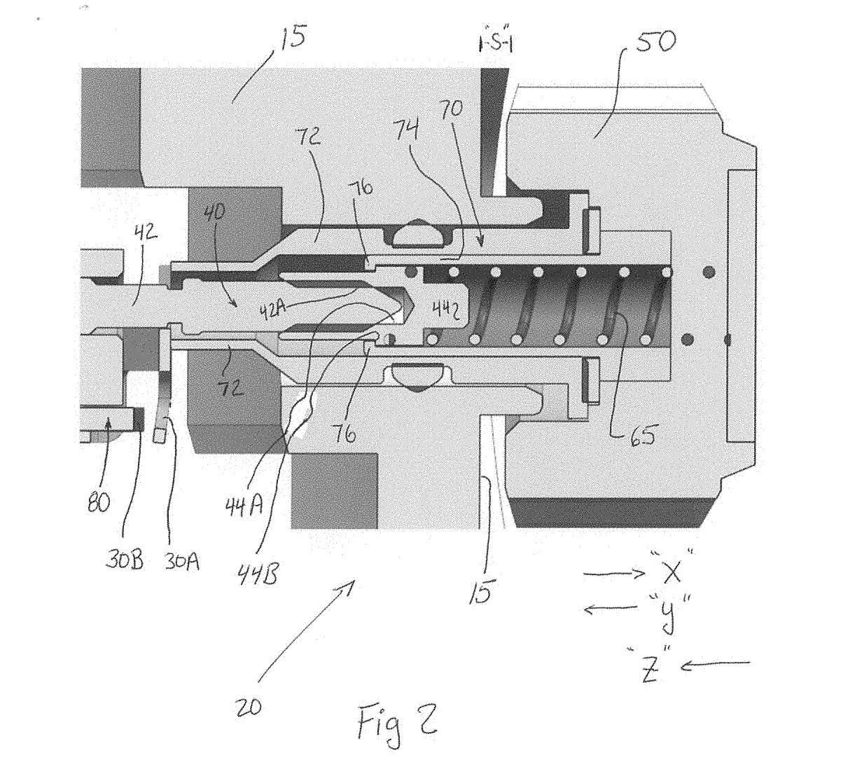

Identical reference numerals in the figures are intended to indicate like parts, although not every feature in every figure may be called out with a reference numeral.

### DETAILED DESCRIPTION OF THE PREFERRED EMBODIMENTS

The present invention is directed to a crown assembly for an electronic device, and in particular, to an improved crown assembly construction for initiating an auxiliary function, such as backlighting. However, backlighting is but one example of a feature or function that can be initiated by the present invention, and other examples thereof can include and any action that is (or could or would be) otherwise initiated or initatable by a pusher or the like.

For example, other functions and features that may be incorporated into an electronic device of the present invention and initiated by the crown assembly of the present invention may be found in U.S. Pat. No. 7,113,450, the subject matter of which is incorporated by reference as if fully set forth herein. For example and not limitation, calibration functionality, speed and distance measurements, display and or stop/starting; or heartrate and/or blood pressure measurements stopping/starting and/or displaying, just to name a few, the important feature being that if it is a feature/function that can be initiated by a pusher, the crown assembly of the present invention can be used to achieve the same.

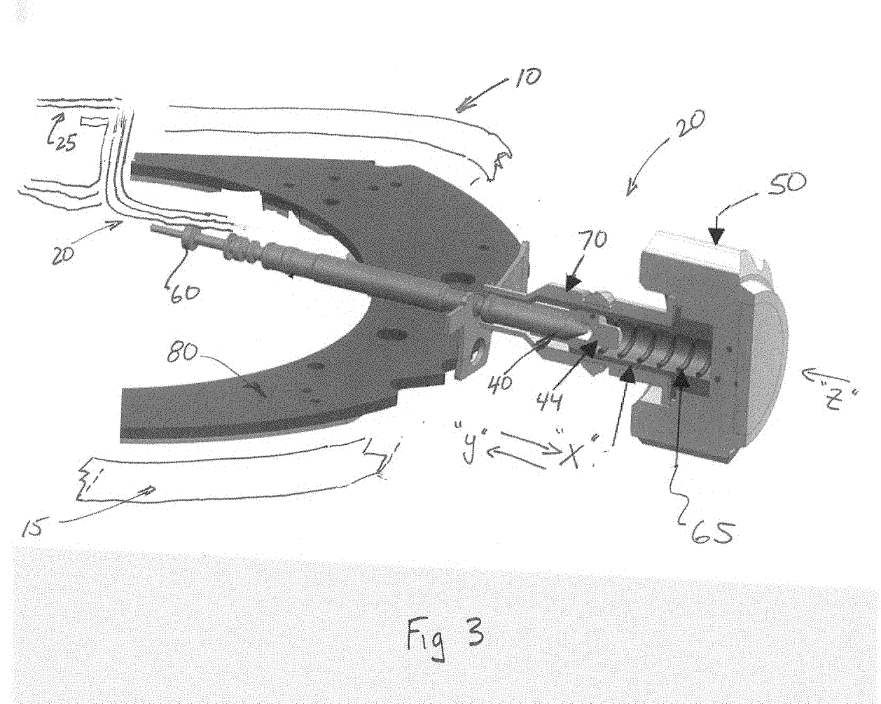

Based thereon, reference is next made to FIGS. 2 and 3 in connection with a crown assembly, generally indicated at 20, constructed in accordance with a first embodiment of the present invention, and preferably used in connection with an electronic device, generally indicated at 10, of the analog-type.

In connection with this first embodiment, electronic device 10 preferably comprises, among other things a watchcase, generally indicated at 15; an indicator adjuster, generally indicated at 22, which in this first embodiment is a gear train and disposed in the watchcase 15; at least one indicator, generally indicated at 25 (FIG. 3) and coupled to the indicator adjuster 22, and which may be one or more indicator hands (e.g. a seconds hand, an hour hand, and/or a minutes hand, or may be a 4^{th} hand or any number of other hands such as those disclosed in the aforementioned '450 patent), an indicator ring (e.g. such as a date ring, day ring or any other number of rings as disclosed in the aforementioned '450 patent) or other indicators; an auxiliary function (e.g. backlighting, laser pointing, etc.) initiatable in response to an electrical contact between two electrical contacts 30A, 30B; a rotatable stem assembly, generally indicated at 40, positioned in the watchcase and axially displaceable between a first “run” position and a second “setting” position; and a setting member 60, coupled to the rotatable stem assembly 40, for engaging the indicator adjuster 22 when the crown 50 is pulled in a first axial direction (i.e. in the direction “X” as illustrated in the figures) from the “run” position of the crown to the “setting” position of the crown.

Crown assembly 20 of this first embodiment comprises a crown 50, external to the watchcase 15 and coupled to the rotatable stem assembly 40, the crown 50 axially displaceable among a first “run” position, a second “setting” position and a third “pushed” position; a biasing member 65 for biasing (i) the crown 50 in the first axial direction and (ii) the rotatable stem assembly 40 in a second axial direction (i.e. in the direction “Y” as illustrated in the figures); a sleeve assembly, generally indicated at 70, coupled to the crown 50 and axially displaceable in both the first and second axial directions, for (i) rotating the rotatable stem assembly 40, (ii) urging the rotatable stem assembly 40 in the first axial “X” direction from the “run” position of the rotatable stem assembly 40 to the “setting” position of the rotatable stem assembly 40, and (iii) causing electrical contact between the two electrical contacts 30A, 30B upon a pushing (e.g. represented by arrow “Z”) of the crown 50 against the sleeve assembly 70 in the second axial “Y” direction to the third “pushed” position of the crown 50.

In accordance with the present invention, the rotatable stem assembly 40 is not further displaced in the second “Y” axial direction from its “run” stem position even though/when the crown is pushed/displaced from the first “run” crown position of the crown 50 to the third “pushed” crown position of the crown 50. In other words, the rotatable setting stem assembly 40 does not move inward towards the electrical contacts 30A, 30B further than the normal “run” position of the rotatable setting stem assembly 40.

Thus, in at least one patentable distinction between the present invention and that described in the aforementioned U.S. Pat. No. 5,644,553, the present invention utilizes the construction of crown assembly 20 to cause electrical contact between the contacts 30A, 30B and initiate the auxiliary function, in patentable contrast to that described in U.S. Pat. No. 5,644,553, which requires that the rotating stem itself be pushed inwardly to cause the electrical contact in order to initiate the auxiliary e.g. “backlighting” function.

In this way, the present invention makes the position of crown 50 of the device 10 of the present invention much more versatile in functionality even when used in connection with watch/electronic device movements that do not otherwise provide for the rotating stem to be pushed inwardly from its normal “run” position, and thus makes conventional movements, e.g. of the timepiece type, much more versatile, as the present invention incorporates a “pushing” feature/function into a crown assembly 20 that would otherwise not have been available or achievable with a rotatable stem that is not constructed to move inwardly further than its normal “run” stem position.

More particularly, in this first preferred embodiment, sleeve assembly 70 preferably comprises an outer sleeve generally indicated at 72 and an inner sleeve generally indicated at 74. Preferably, both outer and inner sleeves 72, 74 may be formed integral with or may otherwise be coupled and/or connected to crown 50. In this way, outer sleeve 72 and inner sleeve 74 are axially displaceable with the axial displacement of crown 50 (i.e. crown 50 and outer and inner sleeves 72, 74 move together in the X and Y directions).

Rotatable stem assembly 40 preferably comprises a rotating stem, generally indicated at 42 and a rotating stem holder, generally indicated at 44. Typically, a conventional rotating stem, such as rotating stem 42, will have a threaded end in anticipation of being threadably coupled to an otherwise conventional crown. Therefore, in accordance with the present invention, a receiving end 44A of stem holder 44 may have a matching threadable recess to receive a threaded end 42A of rotating stem 42. Of course, a friction fit insert or other mating configuration is also contemplated and covered hereby.

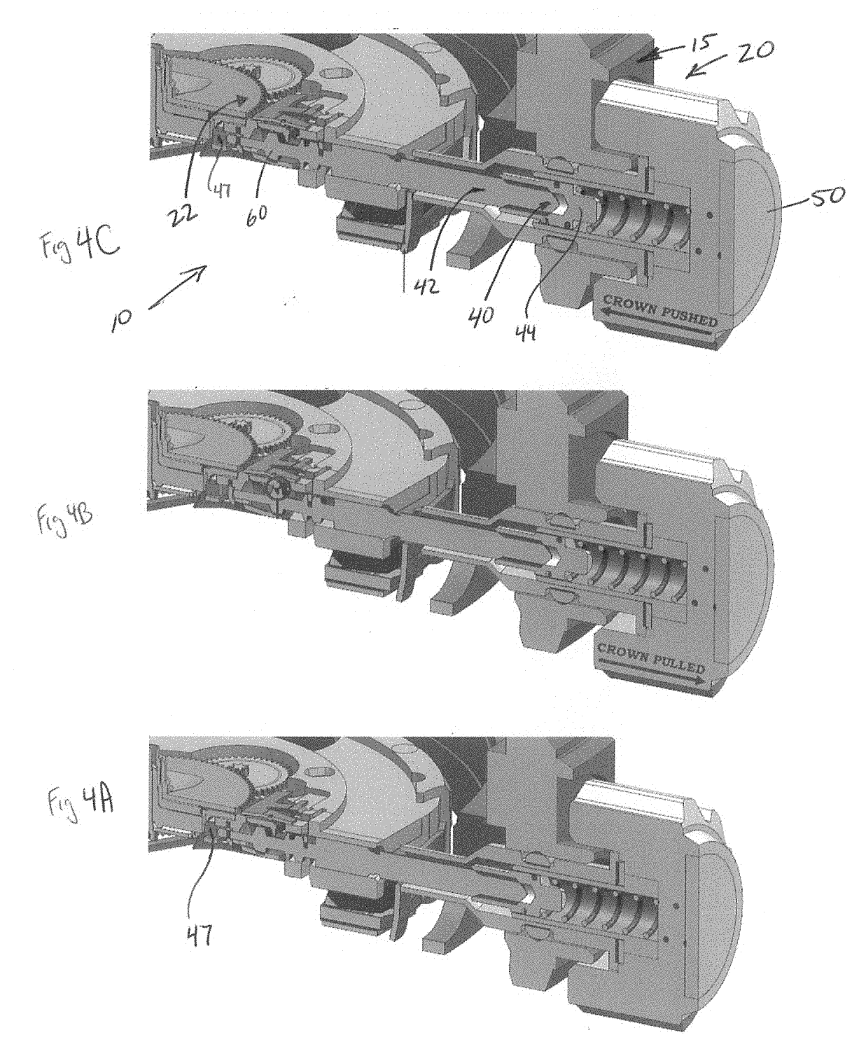

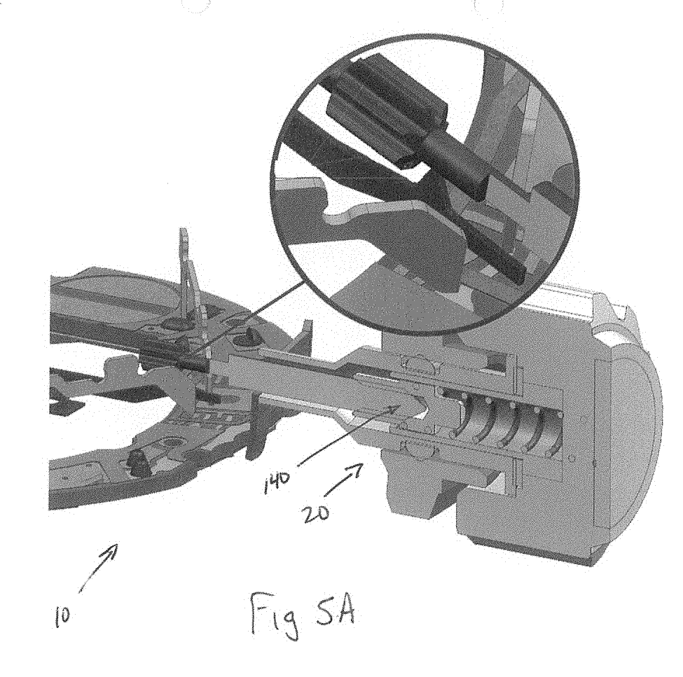

Sleeve assembly 70, and in particular inner sleeve 74, will be preferably dimensioned and shaped to receive therein stem holder 44. In a preferred embodiment, the stem holder 44 has a hexagonal outer profile and the inner sleeve 74 has a matching hexagonal inner profile, although this is by way of example and not limitation, as other complementary shapes are likewise contemplated herein. Importantly however, as illustrated in the figures and discussed further herein, stem holder 44 is axially slidable within sleeve assembly 70, as illustrated generally in a comparison of FIG. 4A (“run” stem position and “run” crown position) and FIG. 4C (“pushing” crown position and “run” stem position).

Preferably, electrical contact 30B may be provided on or coupled/connected to a printed circuit board, generally indicated at 80, by way of solder or other connecting means. Printed circuit board 80 may also be an auxiliary feature be added by way of the present invention in connection with providing the auxiliary function, which may be one or more of the following: backlighting, a laser pointer, or any of the other above-mentioned functionalities as disclosed in the aforementioned '450 patent, just to name a few by way of example and not limitation. Electrical contact 30A may be a switch spring and similarly connected, by solder or otherwise, to the printed circuit board 80. Other connection points for contacts 30A, 30B are contemplated herein.

### Normal “Run” Mode

In accordance with this first embodiment, at or during normal “run” mode, crown 50, sleeve assembly 70, and rotatable stem assembly 40 can freely rotate. In particular, the setting stem holder 44 having a mating profile with the inner dimensions of the inner sleeve 72 (e.g. a hexagonal profile as but one example) results in the interlocking therebetween so that crown 50, sleeve assembly 70 and rotatable stem assembly 40 rotate together, all the while the setting member 60 does not engage indicator adjuster 22.

### “Setting” Mode

In a “setting” mode, such as a time-setting mode by way of example and not limitation, when the crown 50 is pulled-out, the sleeve assembly 70 connected thereto is also “pulled” out in the “X” direction. Sleeve assembly 70 includes a flange 76 at an end of inner sleeve 74 that engages a shoulder 44B of stem holder 44 thus urging the rotatable stem assembly 40 in the first “X” axial direction from the “run” position of the rotatable stem assembly 40 to the “setting” position of the rotatable stem assembly 40. With the rotatable stem 42 threadably coupled to stem holder 44, setting stem 42 is also “pulled-out” in the “X” direction so as to cause the engagement of the setting member 60 with the indicator adjuster 22. Further, the rotation of crown 50 causes the rotation of setting stem 42, which being engaged with the indicator adjuster 22 via the setting member 60 of this first embodiment, causes the rotation, moving and/or setting of the indicator 25 coupled thereto. Again, the indicator could be one or more indicator hands such as an hour and/or minute hand to name but a few examples, or could likewise be a ring, such as date/day ring to name but another few examples. Pushing crown 50 back in the “Z” direction returns the stem assembly 40 to its normal “run” stem position as illustrated in FIG. 4A.

### “Auxiliary Function Initiation” (i.e. “Pushing” Mode)

On the other hand, when the crown 50 is pushed further inwardly from its normal “run” crown position, outer and inner sleeves 72, 74 also are axially displaced in the “Y” direction due to their connection to crown 50. Moreover, the pushing of crown 50 in the “Y”/“Z” direction will urge the biasing of rotatable stem assembly 40 also in the “Y” direction by the biasing of biasing member 65 between the crown 50 and stem holder 44. However, while the rotating stem 42 can be axially displaced in the “Y” direction, rotating stem 42 cannot be axially displaced in the “Y” direction further than its position in the “run” stem position. The prevention of the rotating stem 42 from being axially displaced in the “Y” direction further than its position in the “run” stem position can exist and/or be provided in a number of ways, including the use of one or more flanges (e.g. on stem 42) or the like, or by an endstop 47 (see e.g. FIGS. 4A, 4C) that may be part of the frame and/or may be a separate endstop feature made of material (e.g. plastic and/or metal) as would be well known in the art. To be sure, it should be understood that the existence of endstop 47 (or the aforementioned flanges) might already exist in the movement construction thereby making it not possible for stem 47 to be used in a pushing action. In other words, the existence of endstop 47 is not part of the present invention, but rather, would be a reason why the present invention is so beneficial, i.e. the present invention can be incorporated and/or used with movements that do not already provide a way for stem 42 to be used in an action that desires or requires the pushing of the crown.

In accordance with this first and each and every embodiment of the present invention, sleeve assembly 70 and in a particular embodiment, outer sleeve 72, pushes first contact 30A until it electrically contacts the electronic contact 30B, for example, on PCB 80, thus closing the circuit and initiating the auxiliary function. Again, during the pushing action of the crown 50 into the “pushing” position of FIG. 4C, the setting stem holder 44 and the rotating setting stem 42 can go no further than their respective “run” positions by virtue of one or more flanges or endstop 47 against a front end of the stem 42, thus preventing any displacement of the rotatable stem assembly 40 in the second axial “Y” direction when the crown 50 is pushed from its “run” crown position to its “pushed” crown position. Rather, while the biasing member 65 compresses during the “pushing” action, the rotatable stem assembly 40 remains in its normal “run” stem position and it is by virtue of the axial displacement in the “X” direction of the sleeve assembly 70 (and the outer sleeve 72 in particular) that the physical and electrical contact is made by the displacement of contact 30A towards and against contact 30B.

Preferably, overcompression and/or damage to the crown assembly, when pressed inwardly in the direction “Z” is prevented by a proper balancing of the spring force of spring 65 between crown 50 and stem assembly 40 or by ensuring the distance of displacement is limited by the spacing “S” between the crown 50 and the case body 15.

Removing the pushing action against crown 50 will allow crown 50 to return to its normal “run” position due to the spring memory on (i.e. the biasing function of) the biasing member 65, which in a preferred embodiment is a coil spring. In this way, it can be seen that the pushing and retracting motion of the crown, in combination with the other features and construction set forth above, mimics a push button and the functionality provided thereby.

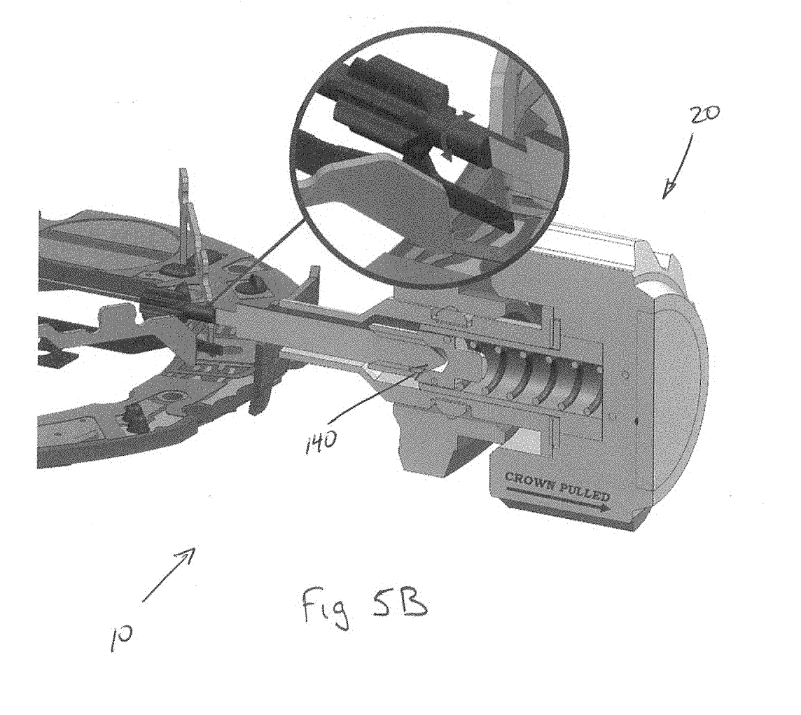

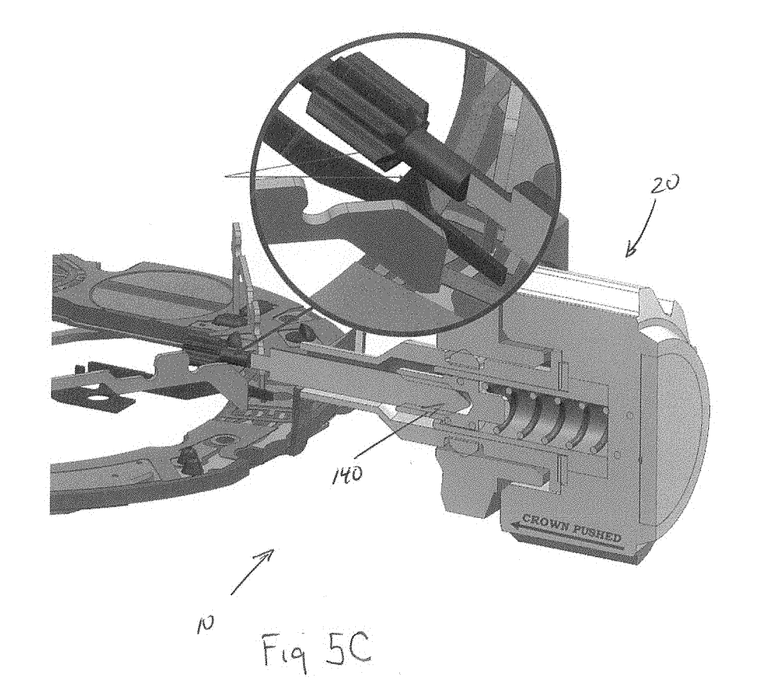

Reference is now made to FIGS. 5A, 5B and 5C in connection with a second embodiment of the present invention, with like parts to the first embodiment either being called out with the same reference numbers or omitted for purposes of convenience. However, the material parts and features of this second embodiment will be called out with its own reference number(s) as set forth herein.

Specifically, the present invention of this second embodiment is constructed and functions identically to that of the present invention of the first embodiment. The main difference of this second embodiment is the additional conventional switching mechanism to which the present invention is applicable. For example, in this second embodiment, it will be readily seen that a rotatable stem assembly, generally indicated at 140, is provided. Particular to this rotatable stem assembly 140 is the incorporation of a plurality of teeth. An exemplary, suitable and incorporateable rotatable stem assembly of this embodiment can be found in coowned U.S. Pat. No. 6,203,190, the subject matter of which is incorporated by reference as if fully set forth herein. In all other respects, the features and functions that make up the present invention are included in this second embodiment, while other aspects of this embodiment, such as, but not limited to, the use of a digital display and/or a microprocessor-based control of the one or more indicators, are also incorporated into this second embodiment as would be understood by those skilled in the art.

Reference can also be made to the aforementioned U.S. Pat. No. 7,113,450, the disclosure of which is incorporated by reference as if fully set forth herein, as the '450 patent provide additional detailed descriptions of how a controller can be used to control the auxiliary function(s), but such detail is not material to the present invention. The present disclosure also omits, for purposes of brevity, certain basic and very well-known concepts regarding the construction of an analog timepiece. For example, the basic construction and arrangements of gears and/or gear trains to rotate a plurality of “standard” hands or ring(s), will be omitted as being well within the purview of one skilled in the art.

Accordingly, it will be seen that the present invention provides an improved crown assembly that can make a conventional watch movement more versatile and user friendly than heretofore. Further, the present invention can eliminate one or more side pushers normally reserved for initiating features or functions that now can be achieved by using the crown assembly of the present invention, and thus provides a timepiece, for example, that may be more functional and aesthetically pleasing to a segment of the purchasing public. The present invention also can be incorporated into a timepiece that uses a standard and/or conventional movement, thereby making such conventional movements much more versatile, along with providing a way for the present invention to be used with a wider range of conventional movements.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall therebetween.

What is claimed is:

1. A crown assembly for an electronic device, wherein the electronic device comprises an auxiliary function initiatable in response to an electrical contact between a first contact and a second contact, and a rotatable stem assembly axially displaceable between at least a “run” stem position and a “setting” stem position, wherein the crown assembly comprises:
a crown, coupled to the rotatable stem assembly, the crown axially displaceable between a “run” crown position and a “setting” crown position and between the “run” crown position and a “pushed” crown position, wherein when the crown is in the “run” crown position the rotatable stem assembly is in the “run” stem position and when the crown is in the “setting” crown position the rotatable stem assembly is in the “setting” stem position; and
a sleeve assembly coupled to the crown and the rotatable stem assembly, the sleeve assembly being axially displaceable in both a first axial direction and a second axial direction that is opposite the first axial direction,
wherein the sleeve assembly:
causes the rotatable stem assembly to be axial displaceable in the first axial direction from the “run” stem position to the “setting” stem position; and
causes electrical contact between the first and second contacts upon a pushing of the crown in the second axial direction to the “pushed” crown position.

2. The crown assembly for an electronic device as claimed in claim 1, wherein the electronic device comprises a watchcase, an indicator adjuster disposed in the watchcase, at least one indicator coupled to the indicator adjuster, and a setting member coupled to the rotatable stem assembly for engaging the indicator adjuster, wherein the sleeve assembly causes the rotatable stem assembly to be axial displaceable in the first axial direction from the “run” stem position to the “setting” stem position so that the setting member can engage the indicator adjuster.

3. The crown assembly for an electronic device as claimed in claim 1, wherein the rotatable stem assembly is not displacable in the second axial direction when the crown is moved from the “run” crown position to the “pushed” crown position.

4. The crown assembly for an electronic device as claimed in claim 1, comprising a biasing member for biasing (i) the crown in the first axial direction and (ii) the rotatable stem assembly in the second axial direction.

5. The crown assembly for an electronic device as claimed in claim 1, wherein the rotatable stem assembly comprises a stem holder, and the sleeve assembly comprises an outer sleeve and an inner sleeve, and wherein the inner sleeve receives therein the stem holder and wherein the stem holder is axially slidable within the sleeve assembly.

6. The crown assembly for an electronic device as claimed in claim 5, wherein the outer and inner sleeves of the sleeve assembly are displaceable in the second axial direction from the “run” crown position to the “pushed” crown position and the outer sleeve comprises a flange that engages a shoulder of the rotatable stem assembly for preventing the displacement of the rotatable stem assembly in the second axial direction beyond its “run” stem position.

7. The crown assembly for an electronic device as claimed in claim 5, wherein the outer sleeve of the sleeve assembly is engageable with the first contact.

8. A crown assembly for an electronic device, wherein the electronic device comprises an auxiliary function initiatable in response to an electrical contact between a first contact and a second contact, and a rotatable stem assembly axially displaceable in a first direction between a first stem position and a second stem position, wherein the crown assembly comprises:
a crown, coupled to the rotatable stem assembly, the crown axially displaceable in the first direction between a first crown position and a second crown position and axial displaceable in a direction opposition the first direction between the first crown position and a third crown position, wherein:
when the crown is in the first crown position the rotatable stem assembly is in the first stem position;
when the crown is in the second crown position the rotatable stem assembly is in the second stem position; and
the rotatable stem assembly is not axially displaceable from the first stem position in the direction opposite the first direction;
a sleeve assembly coupled to the crown and the rotatable stem assembly, the sleeve assembly being axially displaceable in both the first axial direction and the direction opposite the first axial direction, wherein the sleeve assembly:
urges the rotatable stem assembly to be axial displaceable in the first axial direction from the first stem position to the second stem position; and
engages one of the first and second contacts against the other of the first and second contacts when the crown is in its third crown position;
whereby when the first and second contacts are in electrical contact, the crown is in its third crown position and the rotatable stem assembly is in its first stem position.

9. The crown assembly for an electronic device as claimed in claim 8, comprising a biasing member for biasing the crown in the first axial direction and biasing the rotatable stem assembly in the direction opposite the first axial direction.

10. The crown assembly for an electronic device as claimed in claim 8, wherein the rotatable stem assembly comprises a stem holder, and the sleeve assembly comprises an outer sleeve and an inner sleeve, and wherein the inner sleeve receives therein the stem holder and wherein the stem holder is axially slidable within the sleeve assembly.

11. The crown assembly for an electronic device as claimed in claim 10, wherein the outer and inner sleeves of the sleeve assembly are displaceable in the direction opposite the first axial direction from the first crown position to the third crown position and the outer sleeve comprises a flange that engages a shoulder of the rotatable stem assembly for preventing the displacement of the rotatable stem assembly in the direction opposite the first axial direction beyond its first stem position.

12. The crown assembly for an electronic device as claimed in claim 10, wherein the outer sleeve of the sleeve assembly is engageable with the first contact.

13. An electronic device comprising the crown assembly as claimed in claim 1.

14. The electronic device as claimed in claim 13, wherein the electronic device is a wristworn timepiece.

15. An electronic device comprising the crown assembly as claimed in claim 8.

16. The electronic device as claimed in claim 15, wherein the electronic device is a wristworn timepiece.

17. An electronic device, comprising:
an auxiliary function initiatable in response to an electrical contact between a first contact and a second contact;
a rotatable stem assembly axially displaceable between at least a “run” stem position and a “setting” stem position; and
a crown assembly comprising:
a crown, coupled to the rotatable stem assembly, the crown axially displaceable between a “run” crown position and a “setting” crown position and between the “run” crown position and a “pushed” crown position, wherein when the crown is in the “run” crown position the rotatable stem assembly is in the “run” stem position, when the crown is in the “setting” crown position the rotatable stem assembly is in the “setting” stem position and when the crown is in the “pushed” crown position the rotatable stem assembly is in the “run” stem position; and
a sleeve assembly coupled to the crown and the rotatable stem assembly, the sleeve assembly being axially displaceable in both a first axial direction and a second axial direction that is opposite the first axial direction,
wherein the sleeve assembly (i) pulls the stem assembly in the first axial direction from the “run” stem position to the “setting” stem position and (ii) causes electrical contact between the first and second contacts when the crown is in the “pushed” crown position and the rotatable stem assembly is in the “run” stem position.
